(19) United States
(12) Patent Application Publication
(10) Pub. No.: US 2002/0047928 A1
(43) Pub. Date: Apr. 25, 2002

(54) Generating a multi-window video signal

(76) Inventor: Erik De Meersman, Brugge (BE)

Correspondence Address: Michael E. Marion, c/o U.S. PHILIPS CORPORATION,, Intellectual Property Department, 580 White Plains Road, Tarrytown, NY, 10591, US

(21) Appl. No.: 09/930,655

(22) Filed: Aug. 15, 2001

(30) Foreign Application Priority Data
Aug. 16, 2000 (EP) 00202873.6

(51) Int. Cl. H04N 5/445

(52) U.S. Cl. 348/566; 348/565

(57) ABSTRACT

The invention relates to a circuit (2) for generating a composite output picture signal (6) such as a picture signal comprising a PIP (Picture-in-Picture) signal or a DW (Double window) signal on the basis of at least two input picture signals (4.1, 4.2), the circuit comprising a color decoding unit (8) for decoding the at least two input picture signals (4.1, 4.2), and a composing unit (10) for generating the composite output picture signal (6) on the basis of the decoded at least two input picture signals. According to the invention, the color decoding unit (8) comprise a combining unit (14) for combining the at least two input picture signals (4.1, 4.2) into one combined picture signal (16), and one color decoder (18) for decoding the combined picture signal (16) to obtain a single decoded picture signal (12), the composing unit (10) being arranged to generate the composite output picture signal (6) on the basis of the single decoded combined picture signal (12). The invention also relates to a television apparatus provided with a circuit (2) according to the invention, and a display device (D) for displaying the output composite picture signal (6). Furthermore, the invention relates to a video tape recorder provided with a circuit according to the invention.

The invention relates to a circuit for generating a composite output picture signal such as a picture signal comprising a PIP (Picture-in-Picture) signal, or a DW (Double window) signal, on the basis of at least two input picture signals, the circuit comprising color decoding means for decoding the at least two input picture signals and composing means for generating the output picture signal on the basis of the decoded at least two input picture signals. The invention also relates to a television apparatus provided with a circuit according to the invention. Furthermore, the invention relates to a video tape recorder provided with a circuit according to the invention.

Circuits for the generation of composite output picture signals are known and find their application for example in television apparatus and video tape recorders. A disadvantage of these known circuits is that the color decoding means comprise a color decoder for each input picture signal. Since color decoders are relatively expensive elements this yields relatively high priced circuits.

It is an object of the invention to provide in a circuit for the generation of composite output picture signals, which may be substantially cheaper than known circuits. For this the circuit according to the invention is characterized in that the color decoding means comprise a combining means for combining the at least two input picture signals into one combined picture signal and one color decoder for decoding the combined picture signal to obtain a single decoded picture signal, the composing means being arranged to generate the composite output picture signal on the basis of the single decoded combined picture signal. In this way at least one expensive color decoder is saved with respect to known circuits. In the circuit according to the invention the one color decoder performs all decoding operations to be performed in the circuit. While the invention may need more memory than prior art solutions, this is no problem as commercially available memory units often have sufficient capacity to store more than 10 fields.

The combining means may be cheaper than the color decoder. An example of combining means is found in the following embodiment of a circuit according to the invention. This embodiment is characterized in that the combining means comprise a multiplexer for time-multiplexing the at least two input picture signals so as to obtain the one combined picture signal. The multiplexer can comprise a buffer-memory.

In a further embodiment of the circuit according to the invention the composing means comprise a de-multiplexer for the time de-multiplexing of the one decoded combined picture signal into at least two decoded picture signals for further processing to obtain the composite output picture signal. Subsequently the at least two decoded picture signals are processed separately in the composing means. The composing means may further comprise a memory and a micro-processor for the further processing of the at least two decoded picture signals.

In an advanced embodiment of the circuit according to the invention the input picture signals are CVBS-signals. The abbreviation CVBS stands for Composite Video Baseband Signal. The CVBS-protocol is especially used in relation to television apparatuses. In another advanced embodiment of the circuit according to the invention the input picture signals are YC-signals. The YC-signals comprise luminance information Y and chrominance information C. The YC-protocol is especially used in relation to video tape recorders.

An advantageous embodiment of the circuit of the invention is characterized in that the decoded combined picture signal is a YUV, HV-signal and that the composite output picture signal is a YUV, HV-signal.

The invention will now be elucidated with the accompanying drawings in which schematically certain embodiments of the invention are shown:

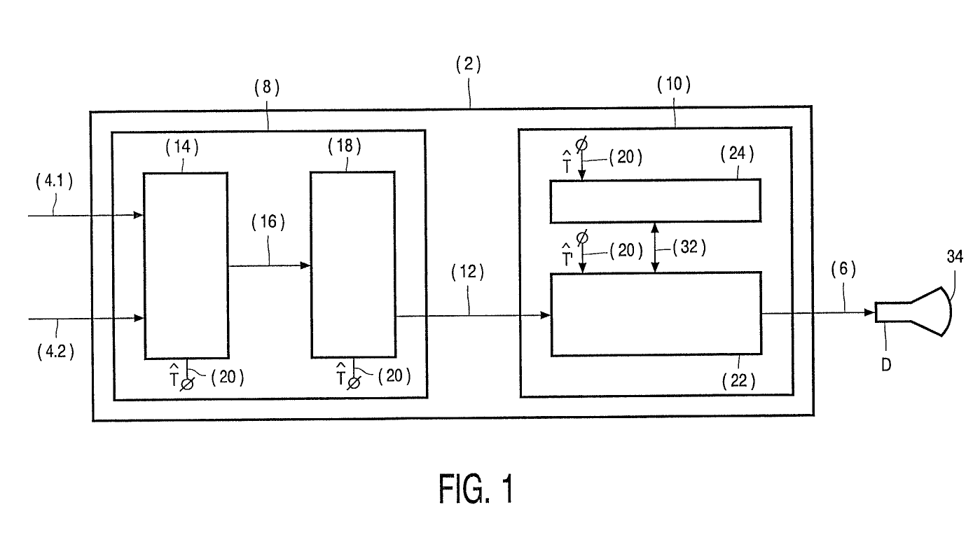

FIG. 1 schematically shows a circuit that can be used in a television apparatus for generating a Picture-in-Picture signal (PIP-signal);

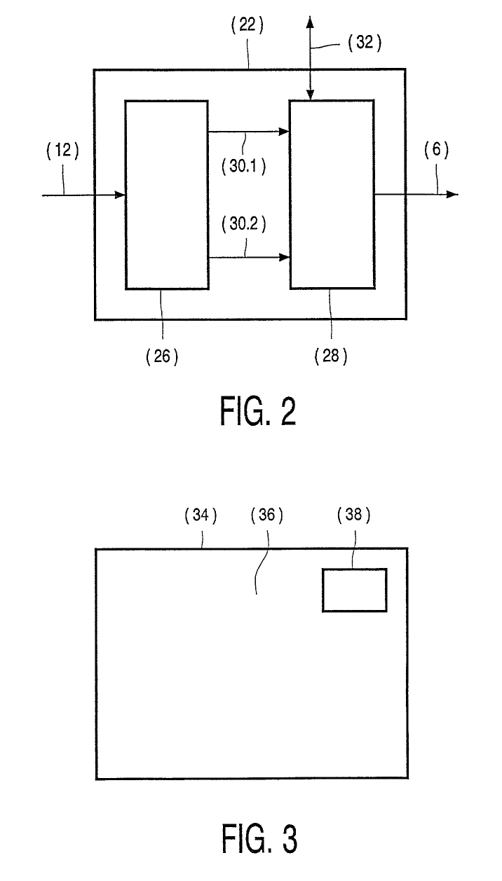

FIG. 2 schematically shows the composing means of the circuit of FIG. 1; and

FIG. 3 schematically shows a depiction of a PIP-signal on a television screen.

FIG. 1 is a diagram schematically showing a circuit 2 which receives two input picture signals 4.1 and 4.2 and which generates a composite output picture signal 6. The circuit 2 is in this example part of a television wherein the input picture signals 4.1 and 4.2 are digital signals which are received from tuners of the television apparatus wherein each input picture signal comprises a coded sequence of images. The input picture signals 4.1 and 4.2 are in this example Composite Video Baseband Signals (CVBS-signals). The composite output picture signal 6 is in this example a picture signal comprising a Picture-in-Picture (PIP) signal. Alternatively, the composite output picture signal 6 is a Double Window signal in which the two input pictures are displayed side by side. The composite output picture signal is displayed on a display device D having a display screen 34.

The circuit comprises a color decoding unit 8 for decoding the two input picture signals 4.1 and 4.2 and a composing unit 10 for generating the composite output picture signal 6 on the basis of the decoded combined picture signal 12.

The color decoding unit 8 comprises a combining unit 14 for combining the two input picture signals 4.1 and 4.2 into one combined picture signal 16. The combining unit 14 comprises a multiplexer for time-multiplexing the input picture signals 4.1 and 4.2 into the one combined picture signal 16. In this example the multiplexer comprises a buffer-memory which is read out by the one color decoder 18. For the timing of the reading process of the color decoder 18 use is made of the timing signal 20 of the circuit 2.

The one combined picture signal 16 is actually a CVBS-signal which comprises the two input-picture signals 4.1 and 4.2, wherein the sequence of images of the two input picture signals are interleaved. This implicates that the data rate of 16 is higher than the data rate of each of 4.1 and 4.2. If the data rate of input picture signal 4.1 equals the data rate of input picture signal 4.2 then the data rate of the one combined picture signal 16 is a factor two higher than the data rate of the input picture signals and consequently the one color decoder 18 operates on a data rate which is a factor two higher than the data rate of the input picture signals 4.1 and 4.2.

The color decoder 18 decodes the one combined picture signal 16 which yields the one decoded combined picture signal 12. The one decoded combined picture signal 12 is a so-called YUV,HV-signal which comprises data-packets containing luminance information (Y), color information UV, and horizontal and vertical synchronization information HV, respectively. The data rate of the decoded combined picture signal 12 (on the level of the data-packets) equals in this example the data rate of the combined picture signal 16.

The composing unit 10 comprises a composing unit 22 and a memory 24.

FIG. 2 is a more detailed diagram of the composing unit 22. The composing unit 22 comprises a de-multiplexer 26 for the time de-multiplexing of the decoded combined picture signal 12 and a PIP-unit 28 which is known per se. The de-multiplexer 26 receives the one decoded combined picture signal 12 and performs a time de-multiplexing operation on this signal, which yields two decoded picture signals 30.1 and 30.2. These two decoded picture signals 30.1 and 30.2 are the input of the PIP-unit 28. The PIP-unit 28 comprises a micro-processor for the processing of the images of the two decoded picture signals 30.1 and 30.2 in a well known manner. This processing yields the composite output picture signal 6. The micro-processor can store information into the memory 24 and read out stored information via the connection 32 for the processing of the two decoded picture signals 30.1 and 30.2. The stored information can comprise processing results and/or intermediate processing results.

FIG. 3 schematically presents a screen 34 of a television on which the composed output picture signal 6 is depicted. The screen depicts one of the input picture signals as a main picture 36 and the other input picture signal as a smaller picture 38 which is inserted on the main picture 36.

In accordance with the provisions of the patent statutes, the present invention has been described in what is considered to represent its preferred embodiments. However, it should be noted that the invention can be practiced otherwise than as specifically illustrated and described without departing from its scope as determined by the claims. For example, the circuit of the invention can generate a multiple-window output picture signal on the basis of input picture signals wherein the output picture signal is depicted on a screen of a television apparatus in such a way that the input picture signals are depicted in separate windows on the screen wherein the windows are non-overlapping. Furthermore the circuit according to the invention can equally be applied in a tape video recorder. In the latter case the input picture signals may be so-called YC-signals.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A circuit (2) for generating a composite output picture signal (6) such as a picture signal (36) comprising a PIP (Picture-in-Picture) signal (38), or a DW (Double Window) signal, on the basis of at least two input picture signals (4.1, 4.2), the circuit comprising:
color decoding means (8) for decoding the at least two input picture signals (4.1, 4.2), the color decoding means (8) comprising combining means (14) for combining the at least two input picture signals into one combined picture signal (16); and one color decoder (18) for decoding the one combined picture signal (16) to obtain a single decoded combined picture signal (12); and
composing means (10) for generating the composite output picture signal (6) on the basis of the single decoded combined picture signal (12).

2. A circuit according to claim 1, wherein the combining means (14) comprise a multiplexer for time-multiplexing the at least two input picture signals (4.1, 4.2) so as to obtain the one combined picture signal (16).

3. A circuit according to claim 2, wherein the multiplexer comprises a buffer-memory.

4. A circuit according to claim 1, wherein the composing means (10) comprise a de-multiplexer (26) for the time de-multiplexing of the decoded combined picture signal (12) into at least two decoded picture signals (30.1, 30.2) for further processing (28) to obtain the composite output picture signal (6).

5. A circuit according to claim 4, wherein the composing means (10) further comprise a memory (24) and a micro-processor (28) for the further processing of the at least two decoded picture signals (30.1, 30.2).

6. A television apparatus provided with a circuit (2) according to claim 1, and a display device (D) for displaying the composite output picture signal (6).

7. A video tape recorder provided with a circuit according to claim 1.
